(19) United States
(12) Patent Application Publication
(10) Pub. No.: US 2013/0116920 A1
(43) Pub. Date: May 9, 2013

(54) SYSTEM, METHOD AND PROGRAM PRODUCT FOR FLOOD AWARE TRAVEL ROUTING

(71) Applicants: Victor Fernandes Cavalcante, Campinas (BR); Bruno Da Costa Flach, Copacabana (BR); Maira Athanazio de Cerqueira Gatti, Rio de Janeiro (BR); Ricardo Guimaraes Herrmann, Sao Paulo (BR); Kiran Mantripragada, Santo Andre (BR); Marco Aurelio Stelmar Netto, Sao Paulo (BR); Lucas Correia Villa Real, Sao Paulo (BR); Paula Aida Sesini, Copacabana (BR); Cleidson Ronald Botelho De Souza, Sao Paulo (BR); Bianca Zadrozny, Rio de Janeiro (BR)

(72) Inventors: Victor Fernandes Cavalcante, Campinas (BR); Bruno Da Costa Flach, Copacabana (BR); Maira Athanazio de Cerqueira Gatti, Rio de Janeiro (BR); Ricardo Guimaraes Herrmann, Sao Paulo (BR); Kiran Mantripragada, Santo Andre (BR); Marco Aurelio Stelmar Netto, Sao Paulo (BR); Lucas Correia Villa Real, Sao Paulo (BR); Paula Aida Sesini, Copacabana (BR); Cleidson Ronald Botelho De Souza, Sao Paulo (BR); Bianca Zadrozny, Rio de Janeiro (BR)

(73) Assignee: International Business Machines Corporation, Armonk, NY (US)

(21) Appl. No.: 13/290,334

(22) Filed: Nov. 7, 2011

(51) Int. Cl. G01C 21/00

(52) U.S. Cl. 701/410; 701/527

(57) ABSTRACT

A travel routing system, method and program product therefor. A location detector detects a current location. A geographical database provides details of a given area. Selecting a destination causes a route generator to generate routes through the area from the current location. A flood simulator receives meteorological data and determines flooding along the routes. A risk-modeling unit determines the risk to travelers of using each route. Before the risk-modeling unit is deployed, it is trained off-line to model travel risks using incidents in an incident data store and simulated flooding in the vicinity of the incidents.

### BACKGROUND OF THE INVENTION

1. Field of the Invention

The present invention is related to systems and methods for routing travel and more particularly to flood aware systems and methods for routing travel.

2. Background Description

Flooded roads are hazardous and flooding has a large impact on traffic flow. Even standing water, when it is deep enough, may make roads impassable for normal land based transportation, e.g., bicycles, cars, buses, and trains, while floodwater two feet deep can float a car. A few inches of moving water can knock a person off her/his feet. Floodwater moving at two miles per hour (2 mph or about three kilometers per hour (3 kph)) can sweep a car off a road or bridge, and cause the car to roll, trapping the driver and passengers and making it difficult or impossible to escape. Moreover, the moving water may erode the road or the shoulder of the road, forming unseen traps for pedestrian and/or vehicular traffic. Consequently, flood-related accidental deaths frequently occur as the result of an attempt to move a stalled vehicle.

Safety personnel and organizations have tried several approaches, not only to reducing risks to travelers' lives and property from flooding, but also to keep translation flowing during floods. Weather alerts only notify in-route vehicles of floods based on information coming from weather radar or satellites. Hazard alerts notify in-route vehicles of accidents, flooding, and construction on local roads and facilitate finding alternative routes to avoid potentially problematic areas. Weather based route generation has been used to generate routes based on current and predicted weather for an area. Other alerts provide travel information on closed roads and areas, travel delays and other travel issues.

Unfortunately, these approaches use relatively brute force routing techniques. These techniques primarily focus on generating a route and one or more alternatives based on fixed criteria. The results notify the traveler of potential hazards, including floods, along the way. These techniques do not, however, inform the travelers of the severity of risk of incidents along the particular route, e.g., whether there is a remote possibility of flooding, as opposed to a high likelihood of areas of rapidly moving floodwaters of frequent accidents occurring during previous flooding.

Thus, there is a need for making the travelers aware of risks in selecting a route to a selected destination and more particularly in assessing increased risk of incidents caused by flooding that occurs along routes to a selected destination and providing notification of the associated risks of those incidents to facilitate route selection.

### SUMMARY OF THE INVENTION

A feature of the invention is associating flooding with routes provided to a selected location;

Another feature of the invention is generating multiple routes to a designation with the risk of hazard associated with incidents occurring along each route;

Yet another feature of the invention is that a traveler is able to designate a destination that lies on the other side of a flood zone or zones, receive a set of routes to the destination through the flood zone(s) with each route having an associated hazard risk indicating the likelihood of incidents along each of the routes.

The present invention relates to a travel routing system, method and program product therefor. A location detector detects a current location. A geographical database provides details of a given area. Selecting a destination causes a route generator to generate routes through the area from the current location. A flood simulator receives meteorological data and determines flooding along the routes. A risk-modeling unit determines the risk to travelers of using each route. Before the risk-modeling unit is deployed, it is trained off-line to model travel risks using incidents in an incident data store and simulated flooding in the vicinity of the incidents.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A and B show an example of traffic routing during flooding situations using a flood-risk-modeling unit according to a preferred embodiment of the present invention;

FIG. 2 shows an example of mapped real time meteorological iconically representing weather from flood simulation;

FIG. 3A shows a mapped example of a risk analysis model with risk iconically indicated and generated from the flood simulation map;

FIG. 3B shows an example of a risk table for risk of incidents along routes from the mapped example.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

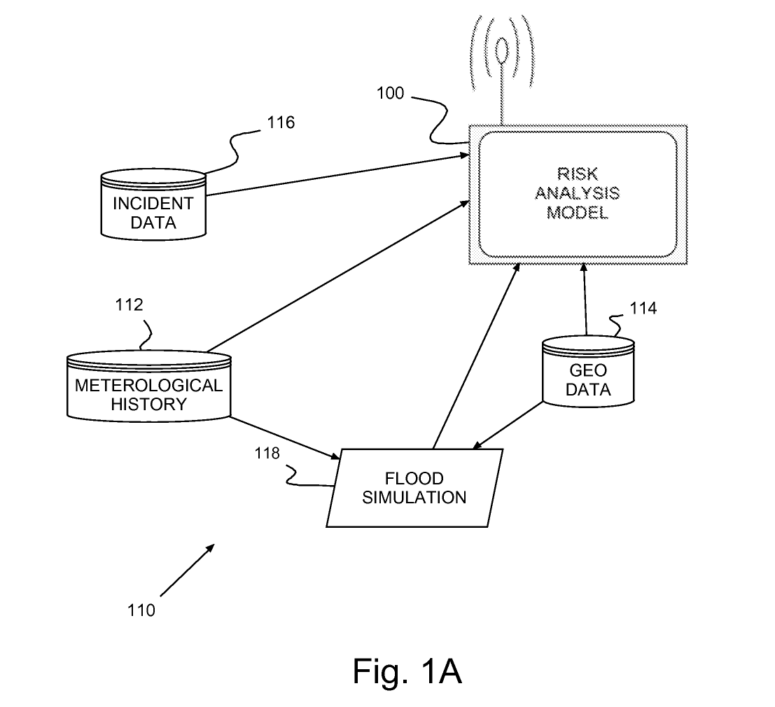

Turning now to the drawings and more particularly, FIGS. 1A and B show an example of traffic routing during flooding situations using a flood-risk-modeling unit 100, e.g., a flooding aware Global Positioning System (GPS), according to a preferred embodiment of the present invention. Preferably, each preferred flood-risk-modeling unit 100, e.g., a stand-alone Bayesian network node or a stand-alone neural network node, is trained offline 110; and then, the trained flood-risk-modeling unit 100 is deployed 120 for real time route generation according to a preferred embodiment of the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Offline training 110 does not rely on real-time data, but instead uses meteorological history data 112, geographical data 114, incident data 116 and simulated weather patterns and results 118, e.g., using a computational numerical simulator by the unit 100 itself, or remotely, on a mainframe computer (not shown) to train the preferred flood-risk-modeling unit 100. Once trained, the preferred flood-risk-modeling unit 100 is deployed and may be carried by a user or hosted by a mobile platform, and generating routes for the user. So, the trained unit 100 is deployed 120, e.g., in a flood-risk aware GPS unit, such as a dash board GPS, a smart phone, or a tablet computer.

Preferably, two types of historical data meteorological history data 112 and incident data 116 are used in training the preferred flood-risk-modeling unit 100. Meteorological data 112 includes weather information such as precipitation, ambient temperature and winds, preferably taken from weather history for the area in the geographical data 114. Incident and accident data 116 lists incidents/accidents and indicates when (date and time), where (geographical coordination points), how (brief description plus any categorization available) each incident/accident happened, and the severity of each occurrence, again preferably taken from incident history for the area in the geographical data 114.

Geographical data 114 is essentially a virtual relief map of, for example, streets, roads, parks and a topological catalog of an area, e.g., rivers, streams, ditches, high points (e.g., hills and mountains) and low points (e.g., valleys) as well as respective altitudes. Moreover, preferably, the meteorological history data 112, geographical data 114 and incident data 116 include real history, incidents and location(s), with a full range of history, incidents, location(s) sufficient for training the preferred flood-risk-modeling unit 100. Thus, the geographical data 114 may be updated and/or supplemented based on subsequent field experience.

A flooding simulator 118 provides a flood forecast using water depth for each point in the domain throughout a given time horizon. In particular, the flood forecast is a hydrological model of a location, e.g., city, state or country, that describes the behavior of surface rain water runoff. The flooding simulator 118 applies a typical well known numerical method to the hydrological location model to provide a solution that describes the area for the particular weather conditions described by data input to the model. Typical input data to the flooding simulator 118, in this example, includes topography information 114 (e.g., geolocation and ground elevation), boundary and initial conditions 112 and precipitation forecast data, past (also 112) and present.

The preferred flood-risk-modeling unit 100 trains to generate flood caused incident risk rated routes. Training uses the hydrological location model 118 with history data 112 and incident data 116 to build a risk model, e.g., using state of the art artificial intelligence (AI) techniques such as stand-alone neural networks and stand-alone Bayesian networks. The risk model correlates incidents/accidents with meteorological data and flood level for different locations and particular meteorological and flooding conditions. Once trained, the preferred flood-risk-modeling unit 100 may be deployed, e.g., sold as a standalone unit or installed with GPS on a motor vehicle, for routing travelers and providing the risk associated with those routes in real time.

The deployed flood-risk-modeling unit 100 of FIG. 1B includes geographical data storage 122 and has access to a flood simulator 124 and real time meteorological information 126. The geographical data storage 122 includes data describing the intended operating area, e.g., a single state or country, and may be the same simulator 118 used in training the unit 100. The flood simulator 124, which may be located remotely or, preferably, with or, part of, the deployed flood-risk-modeling unit 100, may be the same simulator 118 used in training the unit 100. The source of real time weather information 126, e.g., weather sensors and/or data from the National Weather Service, for example, provides real-time meteorological data, instead of the meteorological history data 112 provided during training 110.

Once deployed 120, the preferred flood-risk-modeling unit 100 routes travel 120 based on user input 128, e.g., selecting a destination on a touch screen display 130, and the current location 132, e.g., of the mobile platform or vehicle detected by a GPS. The flood-risk-modeling unit 100, e.g., the GPS, generates a set of available routes between the initial location and the destination. At this time the flood simulator 124 retrieves real time and predicted weather data 126 and geographical data 124 to generate a current hydrological model of the area encompassing the endpoints.

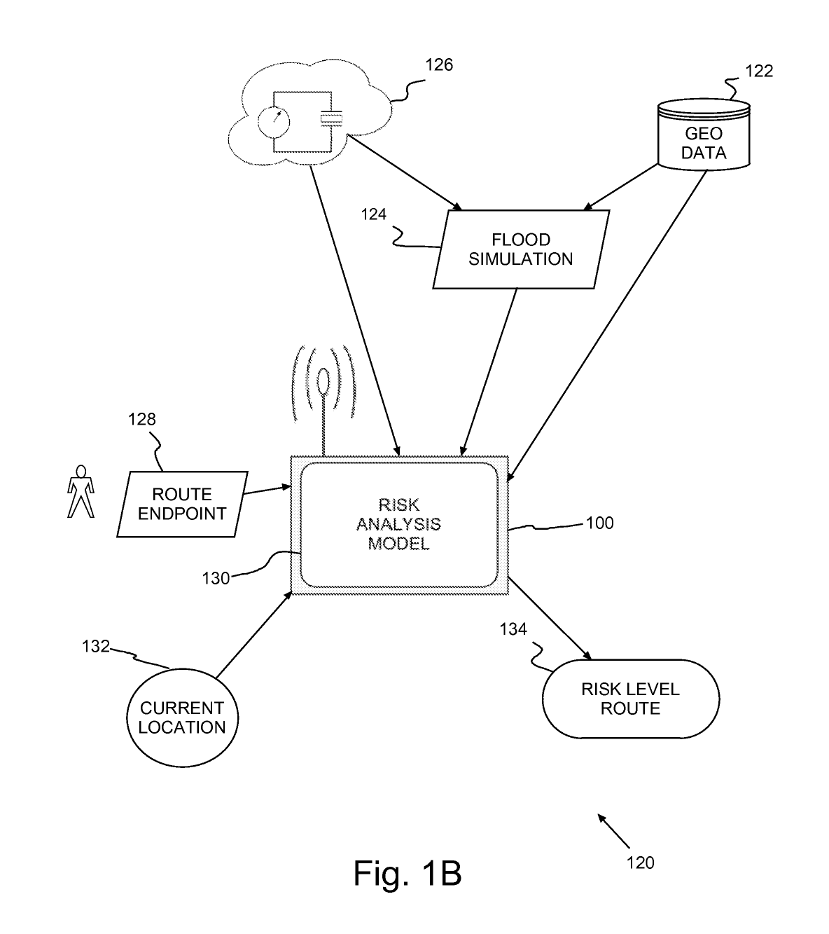

FIG. 2 shows an example of mapped 140 real time meteorological iconically representing weather 142 from flood simulation 124. The extent of flooding is indicated by cloud 142 clusters with the number of clouds in each cluster indicating how heavy flooding is in each particular location.

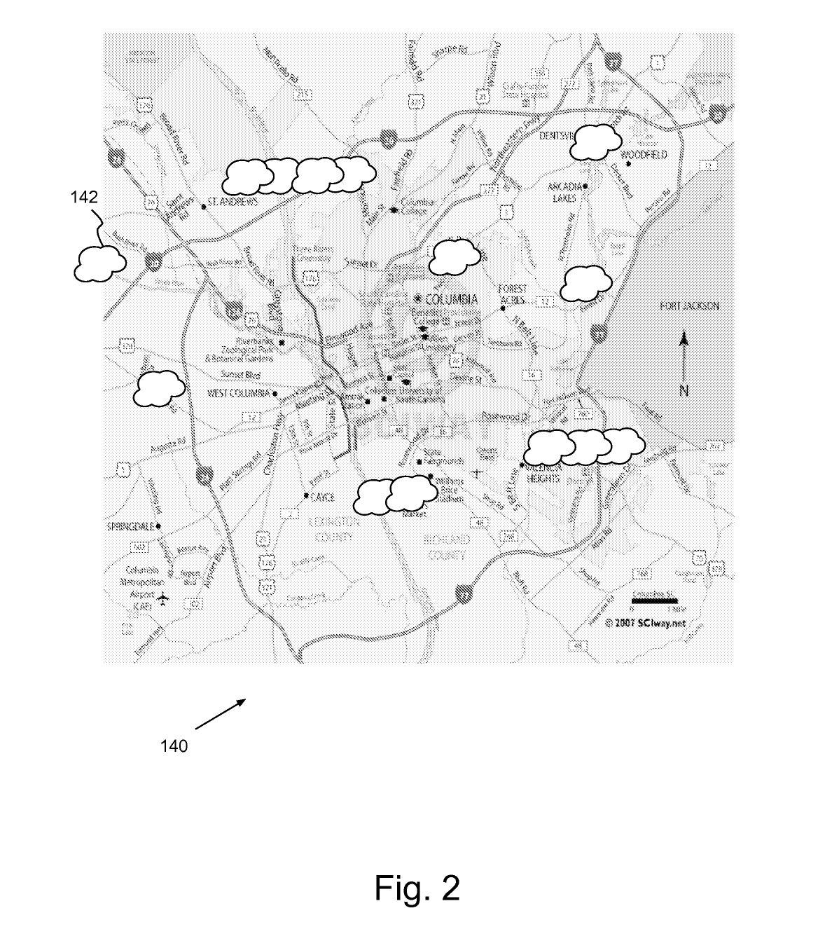

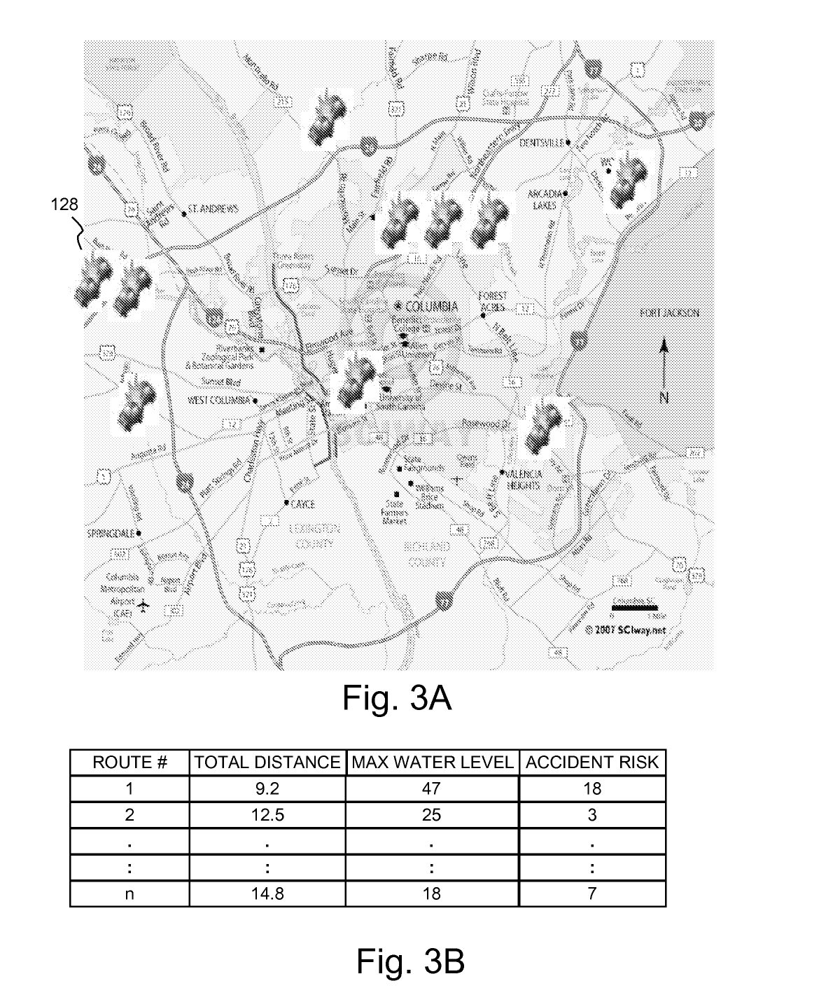

FIG. 3A shows a mapped 150 example of risk results from the risk analysis model prior to application to routes with each risk 152 iconically indicated and generated from the flood simulation map of FIG. 2. Driving hazards are indicated by clusters of crash icons 152 with the number in each indicating the severity of the local hazard. The flood-risk-modeling unit 100 generates multiple routes, preferably ranked according to the flood level, incident risk and length.

FIG. 3B shows an example of a risk table 154 indicating risk of incidents along routes and generated from mapped example 150. In this example, routes are listed 154 in ascending order of driving distance. Preferably, the flood-risk-modeling unit 100 presents the routes and corresponding incident risk ranking, e.g., displayed on a local screen, from which a route may be selected based on incident risk. Optionally, a trip may be re-routed or updated periodically, while moving towards the destination, reassessing risks as weather conditions and flood estimates change.

Thus advantageously, the preferred flood-risk-modeling unit generates a set of translation routes for people and mobile platforms to follow that reduce incident or accident risks and keep the translation flowing in floods. Water level and incident risks are considered in generating the routes from the source to the final destination. Accordingly, the preferred flood-risk-modeling unit simplifies translation and reduces flooding accident risks by providing detailed route information to users for making better informed choices.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A travel routing system comprising:
a location detector detecting a current location;
a geographical database of a given area;
a route generator generating a plurality of routes from said current location through said area to a selected destination responsive to selection of said destination;
a flood simulator receiving meteorological data and determining flooding in said area at each of said routes responsive to said meteorological data; and
a risk-modeling unit determining the risk to travelers using each of said routes.

2. A travel routing system as in claim 1 wherein said location detector is detecting the current location of said travel routing system.

3. A travel routing system as in claim 1, further comprising:
an incident data store storing history of incidents including date and time of each incident, description and type of incident and the severity of the incident;
a weather data store storing history of meteorological events;
a training geographical database of a given training area; and
a training flood simulator determining flooding in said training area responsive to said meteorological events, before said risk-modeling unit is deployed said risk-modeling unit being trained off-line to model travel risks using a plurality of incidents in said incident data store and simulated flooding in the vicinity of said plurality of incidents.

4. A travel routing system as in claim 3 wherein said risk-modeling unit is a stand-alone neural network.

5. A travel routing system as in claim 3 wherein said risk-modeling unit is a stand-alone Bayesian network.

6. A travel routing system as in claim 3 wherein said training geographical database is said geographical database deployed with said risk-modeling unit.

7. A travel routing system as in claim 3 wherein said training flood simulator is said flood simulator deployed with said risk-modeling unit.

8. A method of routing travel comprising:
receiving a destination;
determining plurality of routes to said destination;
simulating flood conditions along said plurality of routes;
modeling travel risks associated with flooding in each of said plurality of routes; and
displaying said plurality of routes with an associated risk of travel incidents.

9. A method of routing travel as in claim 8, wherein a risk-modeling unit models risks, said risk-modeling unit being taught to model risks by a method comprising:
providing a history of incidents including date and time of each incident, description and type of incident and the severity of the incident;
providing a history of meteorological events;
providing geographical data of a given area;
simulating flooding in said area responsive to said meteorological events; and
training said risk-modeling unit off-line to model travel risks using a plurality of said incidents and simulated flooding in the vicinity of said plurality of incidents.

10. A method of routing travel as in claim 9, further comprising deploying said risk-modeling unit.

11. A method of routing travel as in claim 8, further comprising receiving real time weather data, simulating flood conditions being responsive to said real time weather data and weather prediction data.

12. A method of routing travel as in claim 11, further comprising:
receiving a current route selection;
receiving a subsequent travel location; and
updating risks of flooding associated with continued travel from said subsequent travel location responsive to said receiving said real time weather data and said weather prediction data.

13. A method of routing travel as in claim 8, wherein said plurality of routes are displayed on a touch screen display and receiving said destination comprises receiving said destination on said touch screen display.

14. A method of routing travel comprising:
providing a history of incidents including date and time of each incident, description and type of incident and the severity of the incident;
providing a history of meteorological events;
providing geographical data of a given area;
simulating flooding in said area responsive to said meteorological event;
training a risk-modeling unit off-line to model travel risks using a plurality of said incidents and simulated flooding in the vicinity of said plurality of incidents, and deploying said risk-modeling unit.

15. A method of routing travel as in claim 14, further comprising:
receiving a destination;
determining plurality of routes to said destination;
simulating flood conditions along said plurality of routes;
modeling travel risks associated with flooding in each of said plurality of routes; and
displaying said plurality of routes with an associated risk of travel incidents.

16. A method of routing travel as in claim 15, further comprising receiving real time weather data, simulating flood conditions being responsive to said real time weather data and weather prediction data.

17. A method of routing travel as in claim 16, further comprising:
receiving a current route selection;
receiving a subsequent travel location; and
updating risks of flooding associated with continued travel from said subsequent travel location responsive to said receiving said real time weather data and said weather prediction data.

18. A method of routing travel as in claim 15, wherein said plurality of routes are displayed on a touch screen display and receiving said destination comprises receiving said destination on said touch screen display.

19. A computer program product for routing travel, said computer program product comprising a computer usable medium having computer readable program code stored thereon, said computer readable program code causing a computer executing said code to:
receive a destination;
determine plurality of routes to said destination;
simulate flood conditions along said plurality of routes;
model travel risks associated with flooding in each of said plurality of routes; and
display said plurality of routes with an associated risk of travel incidents.

20. A computer program product for routing travel as in claim 19, further comprising computer readable program code for training a risk-modeling unit off-line to model risks by causing said risk-modeling unit to:
receive a history of incidents including date and time of each incident, description and type of incident and the severity of the incident;
receive a history of meteorological events;
receive geographical data of a given area;
receive simulated flooding in said area simulated responsive to said meteorological events; and
use a plurality of said incidents and simulated flooding in the vicinity of said plurality of incidents to assess risks associated with travel in said area.

21. A computer program product for routing travel as in claim 20, further causing a deployed said risk-modeling unit to receive real time weather data, simulate said flood conditions responsive to said real time weather data and weather prediction data.

22. A computer program product for routing travel as in claim 21, further causing said deployed risk-modeling unit to:
receiving a current route selection;
receive a subsequent travel location; and
update risks of flooding associated with continued travel from said subsequent travel location responsive to said receiving said real time weather data and said weather prediction data.

23. A computer program product for routing travel, said computer program product comprising a computer usable medium having computer readable program code stored thereon, said computer readable program code comprising:
computer readable program code means for detecting a current location;
computer readable program code means for a geographical database of a given area;
computer readable program code means for generating a plurality of routes from said current location through said area to a selected destination responsive to selection of said destination;
computer readable program code means for receiving meteorological data and determining flooding in said area at each of said routes responsive to said meteorological data;
computer readable program code means for risk-modeling to determine the risk to travelers using each of said routes; and
computer readable program code means for receiving a current route selection.

24. A computer program product for routing travel as in claim 23, wherein said computer readable program code means for risk-modeling comprises computer readable program code means for a stand-alone Bayesian network.

25. A computer program product for routing travel as in claim 23, wherein said computer readable program code means for risk-modeling comprises computer readable program code means for a stand-alone neural network.
